(19) United States
(12) Patent Application Publication
(10) Pub. No.: US 2013/0169817 A1
(43) Pub. Date: Jul. 4, 2013

(54) METHOD AND SYSTEM FOR ENABLING SMART BUILDING RESCUE

(71) Applicants: Donald R. Jones, New Canton, VA (US); Hussein Mohammed Nosair, Woodbridge, VA (US); Ronald Dubois, Dumfries, VA (US); David E. Kimmel, Fredericksburg, VA (US)

(72) Inventors: Donald R. Jones, New Canton, VA (US); Hussein Mohammed Nosair, Woodbridge, VA (US); Ronald Dubois, Dumfries, VA (US); David E. Kimmel, Fredericksburg, VA (US)

(73) Assignee: NetTalon Security Systems, Inc., Fredericksburg, VA (US)

(21) Appl. No.: 13/534,582

(22) Filed: Jun. 27, 2012

Related U.S. Application Data
(63) Continuation-in-part of application No. 13/313,512, filed on Dec. 7, 2011.

(51) Int. Cl. G08B 25/00

(52) U.S. Cl. CPC G08B 25/00
USPC 348/159; 340/539.2

(57) ABSTRACT

The present invention is directed to providing a method and system that enables a first responder firefighter to take command of a building having a potential fire event. Using the method and system herein, the firefighter is able to clearly signal and guide the safe evacuation of that building. Also mounted in the building are signal arrays that are controlled and triggered by the firefighter to clearly delineate a safe and efficient evacuation route from the building. Room signal stations are provided and can be shown to the first responder firefighter to help prioritize the rescue of a building and allows for interaction and communication between an occupant and a firefighter in order to facilitate or enable more efficient and safer rescue.

The present application is a continuation-in-part application of U.S. patent application Ser. No. 13/313,512, entitled “METHOD AND SYSTEM FOR ENABLING SMART BUILDING EVACUATION”, and filed on Dec. 7, 2011, which is incorporated by reference herein in its entirety.

The present invention relates generally to the efficient and safe monitoring and management of a building in the event of a fire emergency. More particularly, the present invention is directed to a method and system that enables a first responder firefighter to take command of a building having a fire event in order to facilitate and prioritize the safe rescue of any victims trapped by the fire in that building, if necessary.

### BACKGROUND

In a common example, persons who live or work in a building and who are caught in a fire event are typically merely warned about a potential fire event, and preexisting exit routes are illuminated regardless of their proximity to the fire event. These conventional systems may employ a simple on/off siren or alarm in conjunction with the illuminated exit signs.

In some more sophisticated systems, persons in a building who are caught in a fire incident are directed to evacuate the building via an automated voice evacuation system that initializes when a fire alarm control panel goes into an alarm state. Unless the persons view the fire themselves, those persons do not have any direct knowledge whether there even is a fire or, if there is, where the fire is located. Except for not being able to use the elevator in a fire emergency, the only additional information conveyed to persons in the building is to evacuate using the nearest stairwell. Given this lack of information, it is possible that some occupants will be trapped by the fire. Currently, victims have very limited means of communicating their life/death situation. Making a telephone call to 911, or to an in-building operator manned switchboard are the only communication options. Whether or not a first responder firefighter actually receives the distress information will be unknown to the victims. Visual signaling from a window to get firefighter's attention is a second possible option. In all cases, the firefighters do not know the degree of danger the victims are in, how many victims there are trapped and who the priority rescues are. In some cases the presence of trapped victims is totally unknown to the firefighter.

### SUMMARY

The present invention is directed, to providing systems and methods for remotely monitoring sites to provide real-time information that can readily distinguish false alarms from real ones and that can identify and track the location of an alarm and/or its cause with substantial precision. In exemplary embodiments, fire detection capabilities can be implemented through the use of multistate indicators in a novel interface that permits information to be transmitted using standard network protocols from a remote site to a monitoring station in real-time over preexisting communication network transmission pathways (e.g. wire, fiber optic, wireless and satellite). Communications can thereby be established between a centrally located host monitoring station and a separate fire panel deployed in each of the buildings to be remotely monitored. Using this fire detection information, a first responder firefighter is able to identify a need, or not, for evacuation, and also to identify a safe evacuation route. Using the same communication network transmission pathway or pathways, the firefighter can activate visual displays in the building and signaling station in each room, or flat to communicate safe evacuation routes to people in the building. In the event occupants cannot evacuate safely, they can return to the room and use the signaling station to call for rescue. In this way, a firefighter can visually identify rescue needs and then prioritize and strategize an efficient rescue.

In one example, a method for communicating with occupants in need of rescue from inside a building includes several steps. Those steps include providing a plurality of room signal stations adapted to each be able to display and transmit a plurality of different signals; a plurality of fire alarm sensors; a fire alarm panel operatively linked to the room signal stations and to the sensors; and wherein the fire alarm panel is further operatively linked to a firefighter computer. The method also includes installing the room signal stations and sensors in a building and linking them to the fire alarm panel, wherein the room signal stations are positioned and visible within two or more of the rooms of a building. Upon activation of a sensor, an alarm is sent to a firefighter. The firefighter is presented a building floor plan on the firefighter computer. The location of the activated sensor in the building is identified to the firefighter. And upon activation of a room signal station in the building, the location of the activated room signal station is displayed on the firefighter computer to visually guide firefighters in the building. Each room signal station may comprise a video camera directed inside the room of the building where each signal station is installed, and further wherein the video camera is activated upon the activation of the corresponding room signal station and live signal video from the camera is transmitted to the firefighter computer, whereby the firefighter may visually assess a room whose signal station has been activated. Each room signal station may comprise a microphone and a speaker wherein the microphone and speaker are activated upon the activation of the corresponding room signal station. The microphone picks up and sends voice signals from the room to the firefighter and the speaker broadcasts audio signals from the firefighter to the room, whereby a firefighter and a room occupant may verbally communicate with each other. Each room signal station may comprise a communication screen, wherein the communication screen is activated upon activation of the corresponding room signal station, and the screen displays to a room occupant information from the firefighter. Each room signal station may comprise multiple activation keys, wherein each of the keys corresponds to a different message. The building plan presented to the firefighter may comprise visual icons to show the location on the building plan of each fire alarm sensor and each room signal station and also whether each sensor or station is activated or not.

In another example, a system enables communication with occupants in need of rescue from inside a building. The system comprises a plurality of room signal stations adapted to each be able to display and transmit a plurality of different signals and that are further adapted to be installed and visible in rooms in the building. The system also comprises a plurality of fire alarm sensors adapted to be installed in the building. A fire alarm panel is adapted to be operatively linked to the signal stations and to the alarm sensors, wherein the fire alarm panel is operatively linked to a firefighter computer. The firefighter computer is adapted to display a building floor plan that includes icons that show where signal stations and alarm sensors are located and what is the status of each. This system allows a firefighter, in the event of a fire incident, to be able to identify where an occupant is and a safe path to rescue the occupant or otherwise guide them to safety. The firefighter computer may be a mobile computer. Each room signal station may comprise a video camera operatively linked to the firefighter computer and adapted to be directed inside the room where the signal station is installed. Each room signal station may comprise a microphone and a speaker, each operatively linked to the firefighter computer and adapted to pick, send and receive audio signals to and from the firefighter. Each signal station may comprise a communication screen operatively linked to and adapted to receive signals from the firefighter computer. Each room signal station may comprise multiple activation keys, wherein each of the keys corresponds to a different message.

The term “fire panel,” as used in this specification, includes a wide variety of fire panels that are in communication with sensors, and that are capable of providing information to a monitoring system. “Fire panels” may include, but are not limited to, panels for monitoring fire or temperature information, the presence of chemicals or other contaminants in the air, acidity, alkalinity, water pressure, air pressure, wind velocity, magnitude of force, signal integrity, bit error rate, voltage, current, resistance, location of various physical objects, motion, vibration, sound, light, magnetic field, and any other parameters (or changes in parameters) that are measurable by sensors or capable of being determined or identified by processors that process sensor information.

In exemplary embodiments, communications can be transmitted from a centrally located host monitoring system to a mobile monitoring station (for example, to a smartphone, tablet or laptop computer in a responding vehicle, such as a fire vehicle). The transmission can be such that direct communications are established between a fire panel located at a site being monitored and the mobile monitoring station (for example, via communication with a laptop over a wireless network). Alternatively or in addition, indirect communications can be established via a host monitoring station.

The term “parameter” is meant broadly to encompass a wide range of parameters that can be measured by a sensor. Parameters include, but are not limited to, temperature, concentration of various chemicals (such as combustible gases) in the air or elsewhere, water pressure, wind velocity, magnitude of force, a measure of signal integrity or bit error rates in communications transmissions facilities such as fiber-optic cables, geometric position of various mechanical devices such as valves and any other parameter, such as those parameters mentioned herein, that may be measured such that a state or change in state of the parameter may be deter mined. The term “parameter” may also include, as a further example, the state of a signal that displays the location of trapped victims.

The term “firefighter” is meant broadly to encompass a wide range of first responders at a potential fire incident. These first responders are typically a firefighter or other rescue squad personnel. The first responder may also be a policeman or other special rescue team. For the ease of reference, the term “firefighter” is used to include all of these first responders.

Embodiments of the present invention can provide primary visual alarm status reporting that gives the monitoring authority (e.g., a user) the ability to identify the precise location of a fire, and to distinguish false alarms from real ones. Multiple state, or multistate, indications are provided to represent a sensor. For example, in various embodiments, each sensor may be identified as being: (1) currently in alarm; (2) currently in alarm and acknowledged by a monitor; (3) recently in alarm; (4) not in alarm; (5) disabled; or (6) non-reporting. With these multistate indications, the movements of a fire can be tracked, and yet the location of the fire can still be identified with a great deal of precision. This additional tracking ability gives firemen a tactical advantage at the scene as they know the location of the fire with respect to trapped victims and can track any subsequent movements as they close in order to make rescues and to fight the fire. This precise information will tell the fire-ground commander whether he has time to remove the victims from the fire or must knock back the fire to retrieve the victims.

The fire panel is often referenced herein as being located at the space or building. While the physical location of a physical panel can be within the confines of the space or building, the fire panel may also exist remotely in terms of data and information in off-site servers. These off-site servers may also receive and process and present the on-site sensor information and display parameters.

### BRIEF DESCRIPTION OF THE DRAWINGS

FIG. 1 shows an exemplary graphics screen viewed through a fire panel screen, wherein the graphics display contains a floor plan layout, with icons overlaid on a floor pan to identify sensor points and their status and signal array options and their status.

FIGS. 2 and 3 show exemplary graphics screens as described in FIG. 1 except that there are various sensors and signal array icons that are activated in a hypothetical example of a fire/rescue event.

FIG. 4 shows a general overview of communications that occur between four basic subsystems.

FIG. 5 shows a detailed diagram of an exemplary host computer in a supervisory monitoring system.

FIG. 6 shows a detailed diagram of an exemplary remote computer.

FIG. 7 shows a detailed diagram of an exemplary fire panel.

FIG. 8 shows a detailed diagram of an exemplary mobile computer.

FIG. 9 shows an exemplary graphics screen viewed through a fire panel screen, wherein the graphics display contains a floor plan layout, with icons overlaid on a floor plan adapted to identify alarm sensors, room signal stations and their status and signal array options and their status.

FIG. 10 shows an exemplary graphics screen viewed through a fire panel screen, wherein the graphics display contains a floor plan layout, with icons overlaid on a floor plan to identify activated sensors, activated signal stations and their status and signal array options and their status.

FIG. 11 shows an exemplary diagram of the room signal station activated during a hypothetical emergency.

### DETAILED DESCRIPTION

The current method and apparatus maybe implemented together with or partially with the method and apparatus disclosed in earlier U.S. Pat. No. 6,917,288, “Method and Apparatus for Remotely Monitoring A Site”, issued Jul. 15, 2005, which is incorporated herein by reference in its entirety.

The present method and system provide the tools for a first responder, in this case usually a firefighter, to monitor and manage the safe evacuation of a building that is subject to a possible fire event and to successfully rescue any trapped victims. The discussion that follows often references a single building that is being monitored and that is able to be managed by a first responder. The method and system is able to be deployed in two or more buildings equally efficiently.

In each building, a plurality of room signal stations are installed in occupied space such as offices, conference rooms, hotel rooms, etc. The signal stations have touch pads for rescue and to indicate a need for immediate medical assistance. A plurality of fire alarm sensors are also installed in the building. A fire alarm panel is operatively linked to the signal stations and to the sensors and it is further linked to a first responder firefighter computer. When a sensor is activated, an alarm is sent to a firefighter or emergency response center (ERC). The first responder firefighter or ERC is then able to call up a building floor plan on a computer wherein the building is the site of the possible fire event. The firefighter or ERC is able to identify any persons who may be trapped in the building as the activated signal station shows a possible emergency condition for the space where it is located. When the rescue key is touched by a victim, the output is recognized at the alarm control panel and a “Rescue Hot Icon” is displayed on the graphic display of a firefighter computer. The Hot Icon indicates that the video camera and the VOIP (Voice over Internet protocol microphone and speaker) embedded in the signal station are activated for use initiated by the remote monitoring station. The firefighter touches the icon and video and two-way audio to the victims are available. The firefighter or ERS Operator then views the trapped occupants, inquires as to medical condition and instructs the victims to stay where they are and that rescue is on its way. The firefighter gets the number of victims and their condition so there will be enough manpower and rescue/medical equipment to complete the rescue. Also, the firefighter can get names so the identity of rescued victims can be known immediately. The firefighter, just as a 911 operator, continues to talk to the victims to reduce their anxiety and keep them calm.

As the rescue party approaches the floor where the victims are trapped, the firefighter in communication with the victims can alert the victims that the rescue party is approaching. Once the firefighters are on the fire floor, that same firefighter can communicate for the victims to open the door and signal to the firefighters. On the signal station there is a SAFE key pad that the senior firefighter in the rescue party will activate by pressing Safe and Enter. This will change the icon on the graphic display from a rescue condition to a clear condition. The signal station also serves for rescue in an active shooter incident that is ongoing in connection with a developing fire incident started by the shooters. The signal station can have four LEDs Red, Green, Blue and White that indicate either a fire alert (Red), an evacuation condition (Green) or an active shooter condition (Blue) that means stay in place under cover and (White) All Clear-Emergency is Over.

If a shooter attempts to gain entry into an occupied space the trapped occupants can activate the rescue key pad on a room signal station. This, like the fire rescue example, will show an Emergency Hot Icon where a police officer at an Emergency Response Station can access signal station video and communicate to the victims instructions and gain real-time information. The displayed Emergency/Rescue icon tells police where a shooter(s) is/are located and this responding officer can access a hallway camera to get a subject and weapons description. Given this immediate real-time information within the building space, the Command and Control Center can direct a police building entry (equipped with a tactical tablet with the same virtual display) team to the location to engage the subjects and make the rescue.

Specifically, the signal stations are installed and are visually accessible in the occupied building space (offices, residential flats, hotel rooms) and are away from doors so as not to expose a trapped occupant to gunfire if the emergency is an active shooter incident. The signal station also has an audio alert to assist in notification awareness and a flash capability to compensate for color blindness.

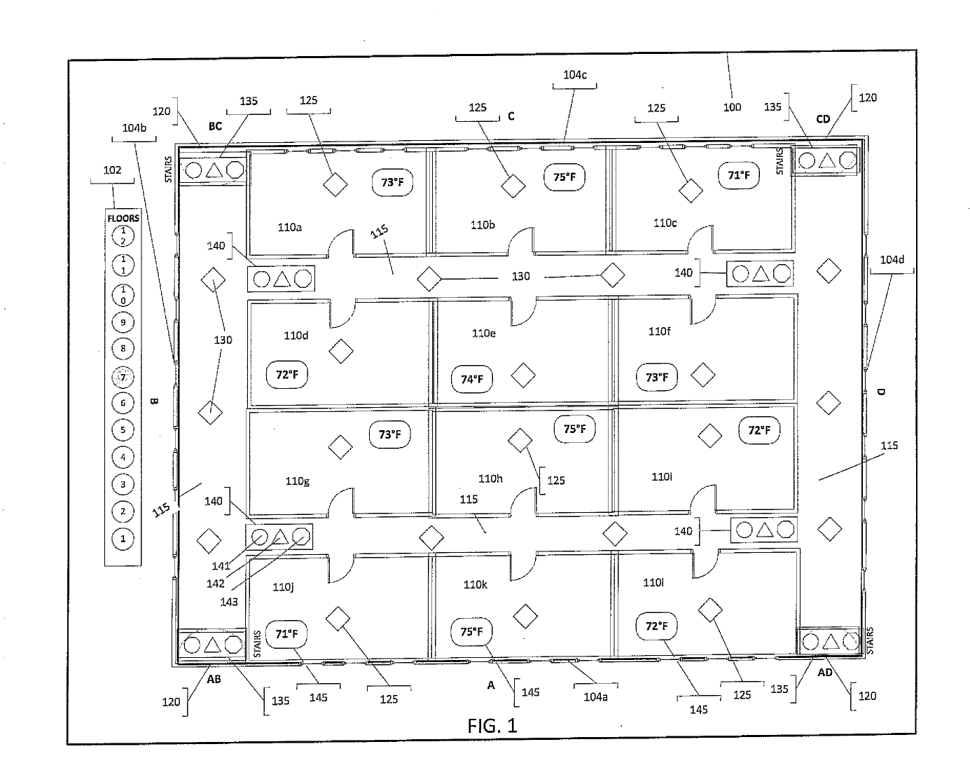

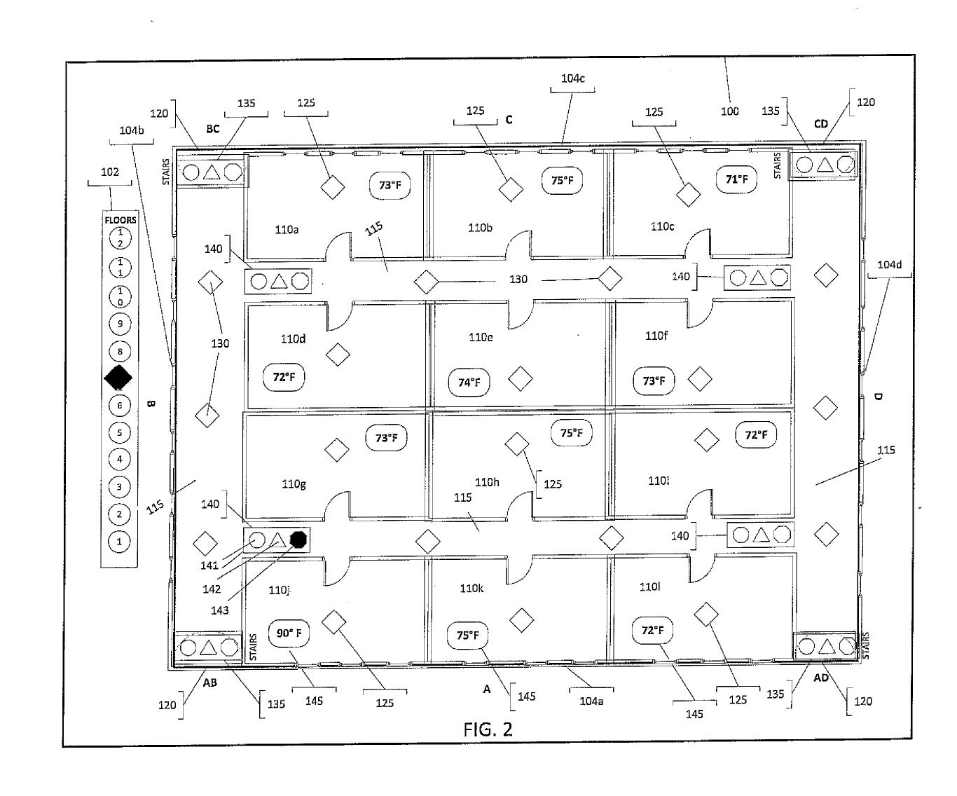

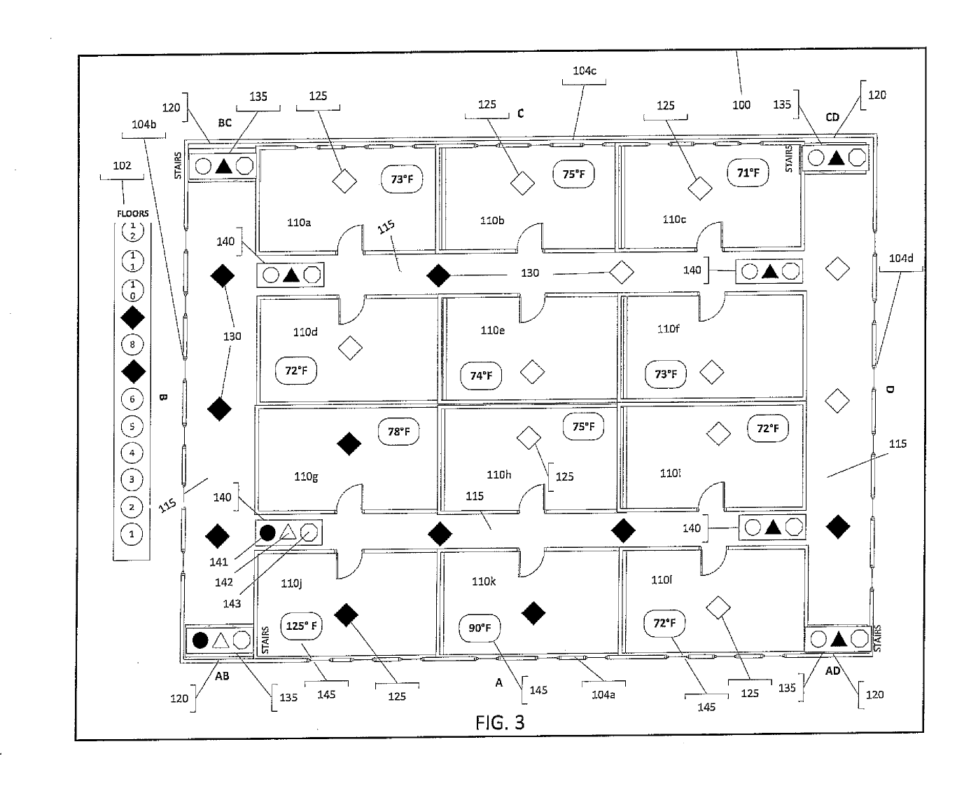

The present system and method are demonstrated in FIGS. 1-3 that show a hypothetical building in a normal monitoring state (FIG. 1), an alarm state (FIG. 2), and (FIG. 3) a safe evacuation state.

FIG. 1 shows a graphics screen containing a floor plan 100 for a building. The hypothetical building has twelve floors as shown in the table 102. The table 102 has activated the circle with the “7” in it to indicate that this floor plan 100 denotes the 7th floor of the twelve floor building. Floor plan 100 includes a rectangular building having four sides 104a-104d. Each of these sides 104a-104d has an indicator A, B, C and D to differentiate the sides of the building floor plan 100.

There are twelve rooms 110 (numbered 110a-1) that are shown in this floor plan 100. Hallways 115 are located in between the rooms 110 and along each end 104b and 104d of the building. Four stairways 120 are shown in each corner of the building floor plan 100 (AB, BC, CD, and AD).

Inside each room 110 there is a fire sensor 125. As described earlier herein, this sensor may detect heat, smoke, or any one or more of numerous additional parameters. Alternatively, the sensor 125 may also be manually activated by a person in a room 110. The hallways 115 also have sensors 130 mounted therein to detect various fire parameters similar to the room sensors 125.

Positioned proximate each stairway 120 is a signal array 135. Each signal array 135 is shown as having three icons 141, 142 and 143 displayed thereon. The icons 141, 142 and 143 are shown separately in this floor plan 100. The actual signal array 135 may contain the multiple icons 141, 142 and 143 or, alternatively, may constitute a single display that may have the functionality to visually display different icons on a single screen. There are also hallway signal arrays 140 that are positioned along the hallways of the floor plan 100. These signal arrays 140 also contain the similar icons 141, 142 and 143. It is envisioned that the hallway arrays 140 may also display directional instructions such as arrows to guide a path when in use.

Finally, there is a temperature display 145 in each room 110 that sets forth the actual temperature in each room 110. This display 145 may also be able to display other information. The temperature display is one example of the type of information that could be displayed in each room 110.

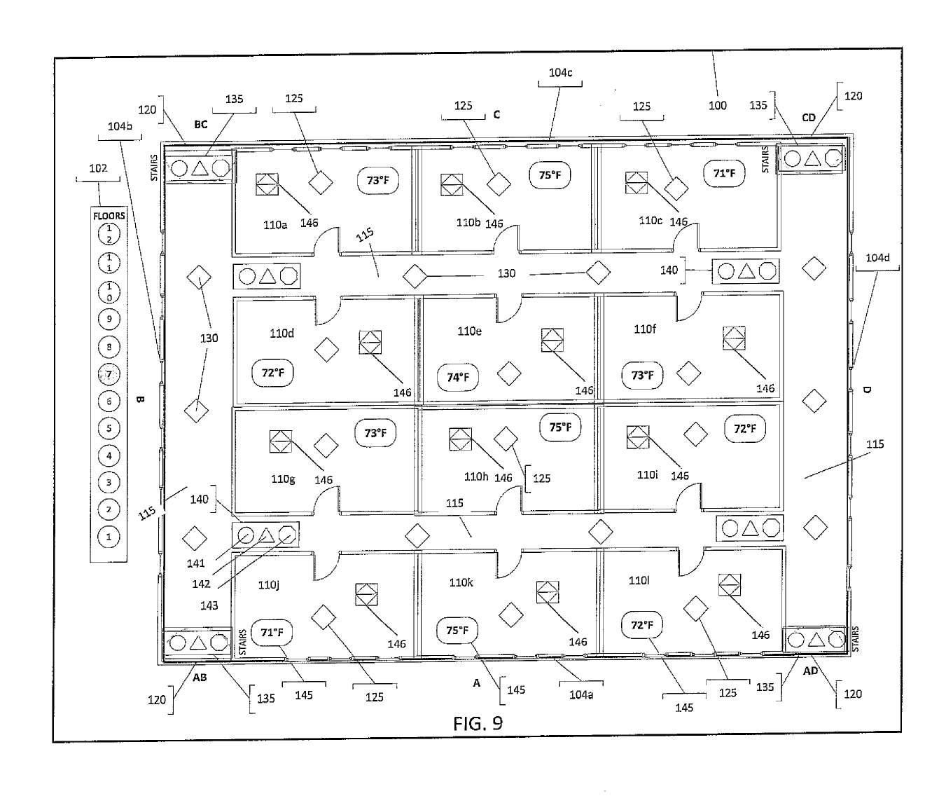

FIG. 1 shows all of the sensors and all of the signal arrays in the open and inactive state with the temperature icon in each room displaying a normal current room temperature. The only icon that is activated is the floor 7 indicator in the table 102 that simply reinforces that this particular graphic illustrates floor 7 of 12. FIG. 9 is similar to FIG. 1 but contains additional icons representing individual room signaling stations 146 in the open and inactive state.

Turning now to FIG. 2, the floor plan 100 of FIG. 2 is essentially identical to the floor plan graphics of FIG. 1 except that an exemplary fire detection event is illustrated. Specifically, as shown in FIG. 2, the floor designator in the table 102 is shown having an activated alarm symbol at floor 7. The image in FIG. 2 also shows that the sensors 125 in the AB corner of the building 100 have been activated as detecting a change in parameter. This change is corroborated by the temperature display 145 in room 110j; that indicates that the temperature in the room has increased to 90° F. The signal arrays 135 and 140 are triggered and show an activated icon 143 that is yellow. This activated icon 143 means that there is a possible fire emergency. This icon may instruct the persons on the floor to remain on that floor unless and until the signal arrays change color or provide other instructions. Accordingly, FIG. 2 is a hypothetical example of the state of the sensors 125 and the location of the sensors 125 on the floor 100. FIG. 2 also shows the state of the signal arrays 135 and 140 and the messages that they are currently transmitting to persons on floor 7 of the building.

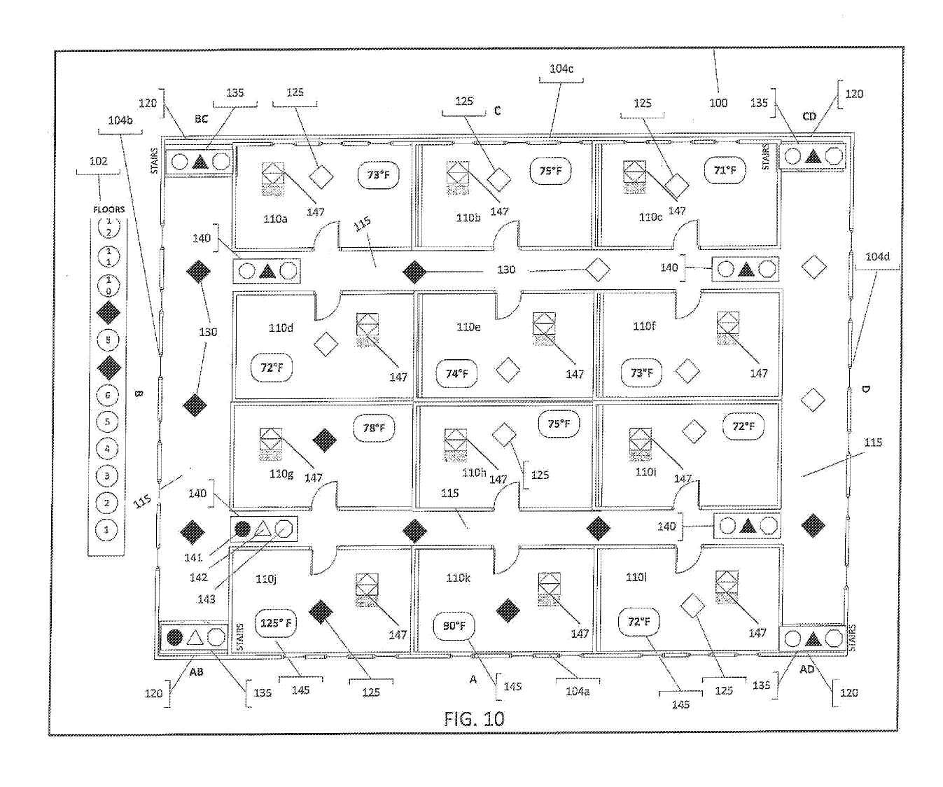

Finally, FIG. 3 demonstrates the activation and instruction of a safe evacuation route from the building 100. FIG. 3 is once again an image of the same floor 100 as shown in FIGS. 1 and 2. In FIG. 3, however, a first responder firefighter has already changed the signal arrays 135 and 140. The first responder is indicating that the stairs 120 in the BC, CD and AD corners of the building 100 are safe for exit. The hallway arrays 140 also illustrate which hallways may be safely passed through by green icon 141. However, the AB corner of the building 100 is shown as having a stop or avoid icon 142 that directs persons away from that stairway. Similarly, the end of the hallway 115 that is proximate the AB corner of the building is likewise designated as a stay-away or no-go area by an icon 142. It should also be noted on FIG. 3 that additional hallway sensors 130 and room sensors 125 have been activated. This provides information to the first responder firefighter to allow them to decide how they may approach the fire. As explained, it also allows the firefighter to define the safe exit routes for persons on the floor as well. The temperature display 145 also shows an increase in temperature in rooms 110g and 110k that communicates to a firefighter the spread of heat from the actual fire. Finally, FIG. 3 also shows in the table 102 that floor 9 has also had sensors triggered that may signal a fire event. This may be caused by any number of reasons such as smoke flow through vents and other ducts. FIG. 10 is similar to FIG. 3 but contains additional icons representing individual room signaling stations 147 in an active state. These signaling stations provide both visual and audio evacuation instructions. Regardless, this is additional information that is available to a firefighter.

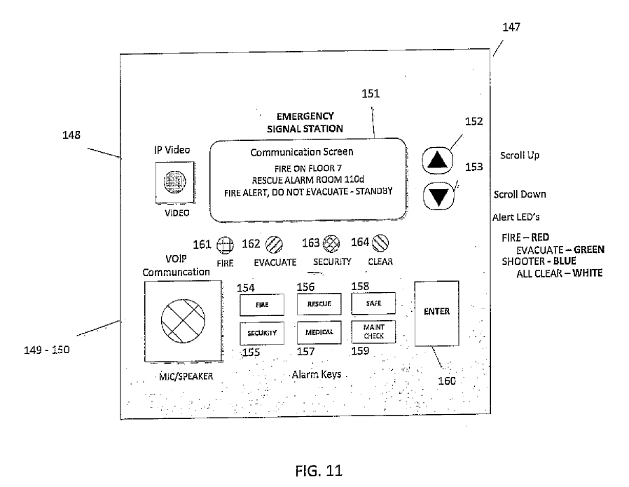

FIG. 11 shows an exemplary drawing of the individual room signal station 147 that includes a video camera 148 activated during an emergency for viewing room occupants, a microphone 149 and speaker 150 activated during an emergency providing direct communications between first responders and room occupants, a three line communication screen 151 used to designate fire floor, rescue alarms, and evacuation instructions. Scroll Up and Scroll Down keys 152-153 allow users to review multiple lines of information while six keys allow an occupant to signal a Fire Alarm 154, a Security Alarm 155, a Rescue Needed Alarm 156, a Medical Emergency Alarm 157, an All Clear Signal 158, and a Maintenance Check 159 key. Occupants select an alarm key and press the Enter Key 160 which sends the information to the Control Panel and Virtual Displays. The signal station houses four brightly colored light emitting diodes (LED's), used to signal emergency type, i.e. FIRE 161 (Red), EVACUATE 162 (Green), SECURITY 163 (Blue), and ALL CLEAR 164 (White) status information.

Exemplary embodiments can provide interactive reporting of facility fire information between four basic subsystems over an Internet/Ethernet communications link. The four subsystems are discussed as follows:

(1) Fire Alarm Panel

This subsystem directly monitors the status of individual sensors and reports their state to the requesting host, remote and mobile computer subsystems. Embedded data sets can be used to provide host, remote and mobile users detailed information on the site.

(2) Host Computer

This subsystem, through a communications interface, provides a real-time display of a regional map depicting the location of all the sites within a security network and their status. Other remote subsystems used to remotely monitor the sites can gain access to the fire alarm panel for each site through the host computer display page. A local graphic interface provides the host computer operator access to the same detailed information. Communications programs operating within the host maintain real-time status of the sites/alarm points and continually update the display screen.

(3) Remote Computer

This subsystem accesses the communication program within the host computer which displays a map of the area sites and their current status. Using a mouse, a site can be selected to view the details of its status. Upon selection, the remote subsystem can be directly connected via a hyperlink to an embedded communication program within the fire panel. Similar to the host computer, the screen updates of site and point status is maintained through a communications program.

(4) Mobile Computer

The mobile computer can gain connectivity to the Ethernet network local to the fire panel through a wireless LAN, once it is within the operating range. “Broadcast packets” (for example, encrypted packets which can be decrypted by the mobile computer) can be sent by the fire panel and be used to instruct the mobile computer how to directly access the fire panel's communication interface through a monitoring station program. Once connected to the fire panel, the mobile computer interface may in some alternatives operate like the remote computer. In other alternatives, the mobile computer can only view the evolving emergency. As used herein, “mobile computer” may refer to a smartphone, tablet or laptop computer or other wireless communication device.

2. General Communications Overview

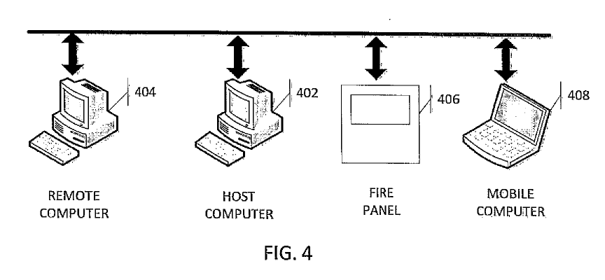

Communications between the various subsystems of embodiments of the present invention are disclosed in FIG. 4. Standard network communication tools may be combined with unique graphics and communication programs to effect real-time performance through minimal bandwidth.

FIG. 4 provides a general overview of the communications that transpire between the four basic subsystems of embodiments of the present invention; that is, (1) a host computer 402; (2) a remote computer 404; (3) fire panel 406; and (4) mobile computer 408. For example, following a powerup indication from the fire panel, and a connection by the host's local communication program to the fire panel's embedded communication program, files regarding site information (such as floor plan) and alarm status information can be sent to the host. Similar protocols can be followed with respect to communications between the remaining subsystems.

Those skilled in the art will appreciate that the information flow represented by the various communications paths illustrated in FIG. 4 are by way of example only, and that communications from any one or more of the four basic subsystems shown in FIG. 4 can be provided with respect to any other one of the four basic groups shown, in any manner desired by the user.

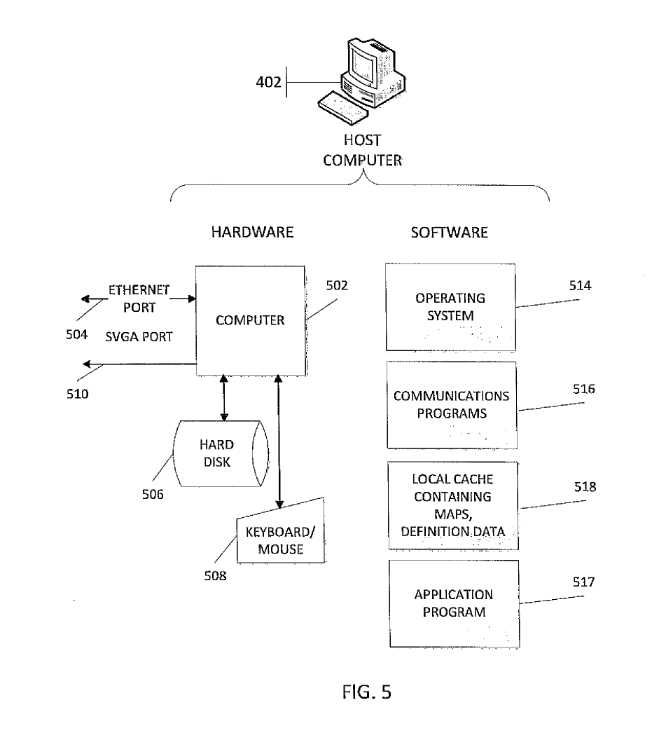

FIG. 5 depicts hardware and software components of an exemplary host computer 402. The CPU motherboard 502 for example, (e.g., based on Intel processor or any other processor) is a conventional personal computer that will support any desired network operating system 514, such as any 32-bit operating system including, but not limited to the Microsoft XP Operating System. An exemplary motherboard will feature, or accommodate, Ethernet communications port 504 for interfacing with an Internet or Ethernet network. A hard disk 506 can be installed to support information storage. A keyboard and mouse 508 can be attached for operator interface. A display, such as an SVGA monitor can be attached via an analog or digital video graphics applications port 510 for a visual display unit. The Operating System 514 can be installed in a standard manner, along with the network communication software package 516. An application program 517 is installed. A local cache directory 518 is installed with supporting graphic files (i.e. regional maps), local definition data files, and any other desired information.

b. Remote Computer

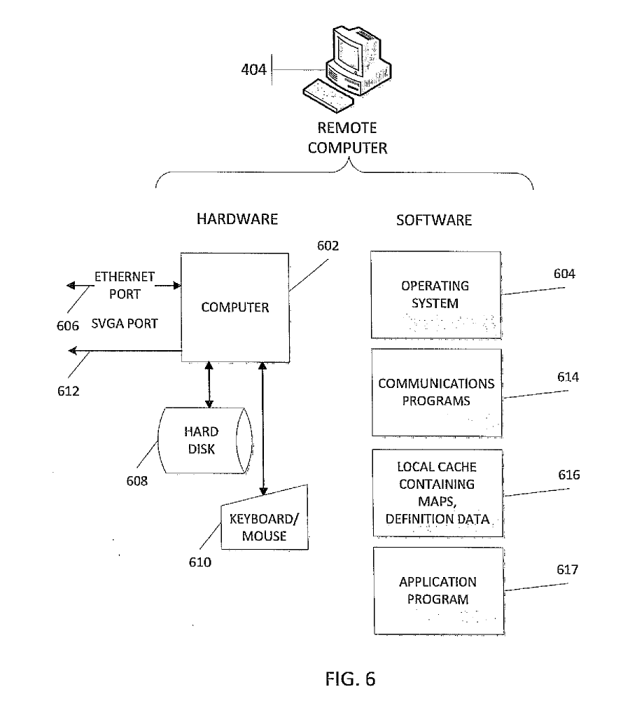

FIG. 6 depicts hardware and software components of the exemplary remote computer 404. The CPU motherboard 602 (e.g., based on Intel processor or any other processor) is a conventional personal computer that will support the desired network operating system 604, such as any 32-bit operating system, including but not limited to the Microsoft XP Operating System. The motherboard will feature, or accommodate Ethernet communications 606 with an Internet or Ethernet network via Ethernet port 606. A hard disk 608 will support information storage. A keyboard and mouse 610 will provide operator interface. An SVGA monitor can be attached via port 612 for a visual display unit. The operating system 604 is installed in a standard manner, along with a communication software package 614. An application program 617 is installed. A local cache directory 616 is installed with supporting graphic files (for example, individual room layouts, floor plans, side view of multi-story facility, and so forth), local definition data files, and other local data files.

c. Fire Alarm Panel

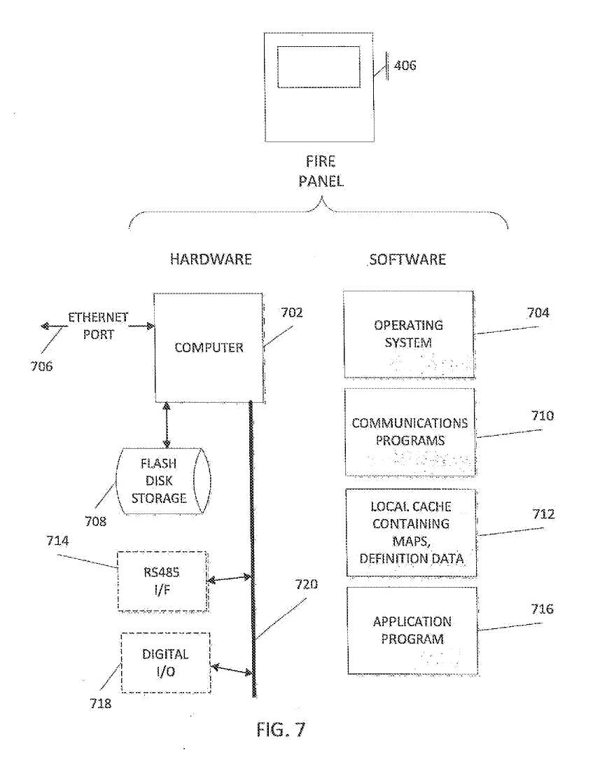

FIG. 7 depicts hardware and software components of the exemplary security/fire panel 407. The CPU motherboard 702 (e.g., based on Intel processor or any other processor) is an embedded computer that will support the desired network operating system 704 such as any embedded 32-bit operating system including, but not limited to the Microsoft embedded XP operating system. The motherboard will feature, or accommodate Ethernet communications with an Internet or Ethernet network via Ethernet port 706. A “flash” disk 708 will support information storage. The operating system can be installed in a standard manner. A communication program 710 is installed. A main application program 712 is also installed, including local data files, and the primary data repository 716 for all graphics and definition files related to the site monitored by this Panel. Communications protocols, such as RS485 communications protocols 714, are supported to facilitate communications with the sensors, sensor controller and other access devices. As supporting inputs, direct digital I/O boards 718 can be added to the local bus 720.

d. Mobile Computer

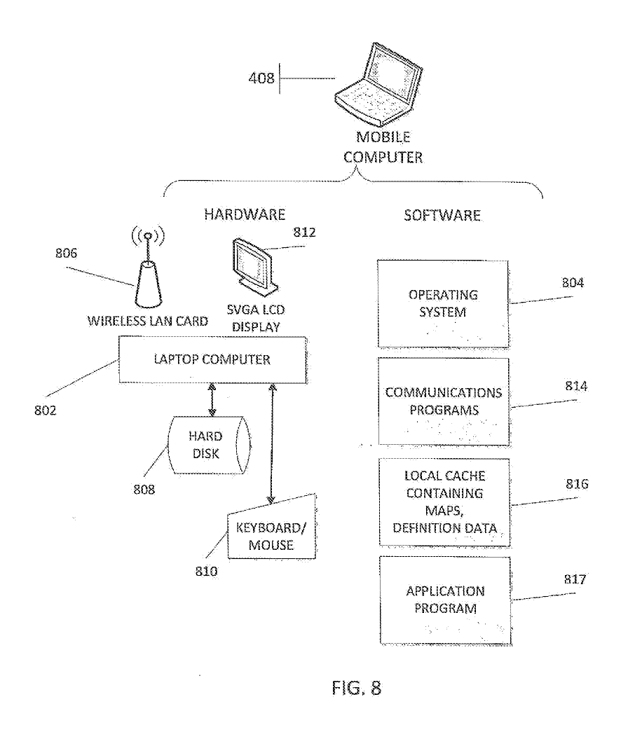

FIG. 8 depicts the hardware and software components of the exemplary mobile computer 408. The CPU motherboard 802 (e.g., based on Intel processor or any other processor) is a conventional laptop computer or other mobile computing platform that will support the desired network operating system 804, such as any 32-bit operating system including, but not limited to the Microsoft XP Operating System. Add-on boards can be installed to interoperate with, for example, IEEE 802.11 Ethernet communications 806. A hard disk 808 is installed to support information storage. An integral keyboard and mouse 810 are attached for operator interface. A display, such as an SVGA LCD monitor 812 is attached for a visual display unit. The operating system can be installed in a standard manner, along with a communications software package 814 and application software package 817. A local cache directory 816 is installed with supporting graphic files (i.e. individual room layouts, floor plans, side view of multi-story facility, and so forth), local definition data files, and other local data files.

d. Mobile Fire Panel Communications

The mobile computer may gain access to the fire panel through a wireless local area network, enabled by a wireless LAN hub and/or any available wireless network including, but not limited to existing cellular telephone networks. The mobile computer communication software is executed and seeks to connect to the fire panel's embedded communications program. When access is allowed, the remote computer requests that the embedded communication program download the definition data files that define the fire panel's display page. The definition data files include a reference to a graphics file. If the current version of the file does not locally exist, the remote computer requests the HTTP transfer of the graphics file from the fire panel. Once received from the fire panel in response, the graphics file is locally stored (in cache directory) and is displayed. Once the required data is determined to be located on the remote computer, the communications program begins a continuous polling sequence, requesting the status of the various points via a status request. When the communications program receives the response status messages, all the icons overlaying the graphics screen are repainted to indicate the current status of the points.

The signal arrays are installed proximate exit door ways. However, in the event that the exit doorways are spaced apart in any substantial length, then the display arrays may be mounted in sequential distances between the various exit doors. The signal arrays may alternatively also be mounted in each room. The signal arrays may have any number of visual signals programmed to be presented to a person in the building.

The amount of information that may be conveyed is limited only by the reasonable visual surface of the array and the complexity of the signal to be communicated. Those signals may include words and/or sound instructions, for instance voice instructions. They may include different multicolored visual signals. These signals are activated and are under the control of a first responder so that the first responder or professional can identify the safe evacuation route.

In still further examples, the signal arrays mounted in one or more of the stairwell, hallway or room locations may include interactive audio abilities. The signal arrays may be activated to give general audio instructions regarding a fire event and evacuation. The signal arrays may be programmed to allow a first responder to send custom audio messages. The signal arrays may also be able to be activated for direct verbal communications between a person in a room, hallway or stairwell and a first responder or other monitor of a developing situation in a building. Different protocols may be used to activate the various audio messages or audio interactions that may be appropriate or needed.

In another embodiment of the present invention, sensors are provided at various locations in the space that is to be monitored. These sensors are able to provide real-time or substantially real-time monitoring of an environmental or other parameter and provide signals indicating a value of the parameter. Each sensor is in communication with one or more fire panels, as described above. In embodiments of the present invention, the fire panel monitors the status of the various sensors, for example, by polling the sensors at regular time intervals, such as 1.5 seconds, or other intervals appropriate to the space and parameter being monitored.

In an embodiment of the present invention, the fire panel is in communication with a supervisory monitoring system at an ERC, which, as described above, can include a host computer configured with an communication program. The supervisory monitoring system is provided with a visual display to graphically represent the status of the various sensors. For example, in the case of temperature sensors, the visual display of the supervisory monitoring system may represent numerically the latest reported temperature at each of the temperature sensors. In the case of a sprinkler control valve, the visual display of the supervisory monitoring system may represent the latest state of the valve (OPEN, RECENTLY OPEN or CLOSED) at each sprinkler control valve. In addition, various alarm states, as described below, may be represented, such as by differently colored icons or by other representations as discussed below and as apparent to one of skill in the art in view of this specification.

In another embodiment of the present invention, a plurality of sensors are located at various predetermined monitoring locations of a space to be monitored. As described above, these sensors monitor an environmental or other parameter and provide signals indicating the value of the parameter to a fire panel. As the state of the sensor changes in response to changes in the value of the parameter being measured, the fire panel will provide self-initiated real-time or substantially real time notification signals to a monitoring system indicating the new state of the sensor. In an embodiment, the fire panel will only provide the real-time or substantially real-time self-initiated notification signal in the event of a change in the sensor that exceeds a predetermined value. For example, in the case of temperature sensors, the fire panel may be programmed only to provide a notification signal if the change in temperature is greater than 1 degree F. In another embodiment, the fire panel may be programmed to provide a notification signal after a predetermined period of time, or at predetermined intervals after an initial notification signal triggered by a high-end, low-end, rate-of-change or other alarm.

In such embodiments, the monitoring system is provided with a visual display that represents the space being monitored with sensor control valves. In diagrams such as floor plan diagrams, different colors or shadings of the icons may be used to represent different values of a parameter. A parameter measurement as determined by a sensor may also be displayed digitally and/or through display of different colors, shadings, and other variations of a corresponding icon.

In embodiments of the present invention, alarm information is transmitted to and displayed by a monitoring system including one or more mobile devices, such as personal computers equipped with wireless communication capabilities, used by firefighters or hazardous materials or other response personnel as they travel to the space in response to an alarm. As the sensor states change in response to parameter-value changes in the monitored space, these response personnel can receive that information in near real-time, and can develop a strategy, as they travel to the monitored space, for addressing the problem that triggered the alarm. In situations where an alarm requires responses by multiple teams—such as a large fire or chemical fire requiring fire, police, rescue and environmental teams—embodiments of the present invention provide each team with mobile monitoring capabilities displaying the same information, including changes about the alarm situation, in near real-time. An ERC may take command, for example, to manage the multiple first responder team response. These teams thus have the ability to develop a plan and coordinate their planned actions as they travel to the monitored site, thus improving the timeliness and effectiveness of their response and enhancing their own safety.

Other embodiments of the present invention will be apparent to those skilled in the art from consideration of the specification. It is intended that the specification and Figures be considered as exemplary only, with a true scope and spirit of the invention being indicated by the following claims.

What is claimed is:

1. A method for communicating with occupants in need of rescue from inside a building comprising the steps of:
providing a plurality of room signal stations adapted to each be able to display and transmit a plurality of different signals; a plurality of fire alarm sensors; a fire alarm panel operatively linked to the room signal stations and to the sensors; and wherein the fire alarm panel is further operatively linked to a firefighter computer;
installing the room signal stations and sensors in a building and linking them to the fire alarm panel, wherein the room signal stations are positioned and visible within two or more of the rooms of a building;
upon activation of a sensor, sending an alarm to a firefighter;
presenting a building floor plan to the firefighter on the firefighter computer;
identifying to the firefighter the location of the activated sensor in the building; and
upon activation of a room signal station in the building, displaying the location of the activated room signal station on the firefighter computer to visually guide firefighters in the building.

2. The method described in claim 1, wherein each room signal station comprises a video camera directed inside the room of the building where each signal station is installed, and further wherein the video camera is activated upon the activation of the corresponding room signal station, and transmitting the live signal video from the camera to the firefighter computer,
whereby the firefighter may visually assess a room whose signal station has been activated.

3. The method described in claim 1, wherein each room signal station comprises a microphone and a speaker, and further wherein the microphone and speaker are activated upon the activation of the corresponding room signal station, wherein the microphone picks up and sends voice signals from the room to the firefighter and the speaker broadcasts audio signals from the firefighter to the room,
whereby a firefighter and a room occupant may verbally communicate with each other.

4. The method described in claim 1, wherein each room signal station comprises a communication screen, and further wherein the communication screen is activated upon activation of the corresponding room signal station and the screen displays to a room occupant information from the firefighter.

5. The method described in claim 1, wherein each room signal station comprises multiple activation keys, and wherein each of the keys corresponds to a different message.

6. The method described in claim 1, wherein the building plan presented to the firefighter comprises visual icons to show the location on the building plan of each fire alarm sensor and each room signal station and also whether each sensor or station is activated or not.

7. A system to enable communication with occupants in need of rescue from inside a building comprising;
a plurality of room signal stations adapted to each be able to display and transmit a plurality of different signals and adapted to be installed and visible in rooms in the building;
a plurality of fire alarm sensors adapted to be installed in the building;
a fire alarm panel adapted to be operatively linked to the signal stations and to the alarm sensors; and wherein the fire alarm panel is operatively linked to a firefighter computer;
wherein the firefighter computer is adapted to display a building floor plan that includes icons that show where signal stations and alarm sensors are located and what is the status of each;
whereby a firefighter, in the event of a fire incident, is able to identify where an occupant is and a safe path to rescue the occupant or otherwise guide them to safety.

8. A system as described in claim 7, wherein the firefighter computer is a mobile computer.

9. A system as described in claim 7, wherein each room signal station comprises a video camera operatively linked to the firefighter computer and adapted to be directed inside the room where the signal station is installed.

10. A system as described in claim 7, wherein each room signal station comprises a microphone and a speaker, each operatively linked to the firefighter computer and adapted to pick up, send and receive audio signals to and from the firefighter.

11. A system as described in claim 7, wherein each signal station comprises a communication screen operatively linked to and adapted to receive signals from the firefighter computer.

12. A system as described in claim 7, wherein each room signal station comprises multiple activation keys, and wherein each of the keys corresponds to a different message.
